(19) United States
(12) Patent Application Publication
(10) Pub. No.: US 2008/0013803 A1
(43) Pub. Date: Jan. 17, 2008

(54) METHOD AND APPARATUS FOR DETERMINING PRINT IMAGE QUALITY

(75) Inventors: PETER Z. LO, LAKE FOREST, CA (US); BEHNAM BAVARIAN, NEWPORT COAST, CA (US); YING LUO, IRVINE, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/457,273

(22) Filed: Jul. 13, 2006

(51) Int. Cl. G06K 9/00

(52) U.S. Cl. 382/124

(57) ABSTRACT

A method, apparatus and computer-readable storage element for determining quality of a print image, with the method including the steps of: estimating a centroid point of the physical print; setting dimensions of a quality computation frame based at least on a characteristic of the print image; centering the quality computation frame around the centroid point; determining, within the frame, a set of quality features; and computing a quality measure for the print image based on the set of quality features.

### FIELD OF THE INVENTION

The present invention relates generally to print image processing and more particularly to determining a quality measure for a print image.

### BACKGROUND OF THE INVENTION

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, are extracted. The personal information and the extracted features are then used to form a file record that is saved into a database for subsequent print identification. Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of matched scores is generated after the matching process. Candidate records are sorted according to matched scores. A matched score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

The quality of print images affects the workload for a human examiner. This is because certain print images that may not actually be as useful in print identification (for example those having an insufficient matching area) may be inaccurately identified as having sufficient quality to be included in the identification stage. These same print images may be incorrectly output as candidates (or completely missed in a candidate list). Since ideally these prints should be eliminated in the enrollment stage due to insufficient quality, the unreliable acceptable quality assessment for these images can cause corresponding unreliability in them as candidates (and true candidates missed) being output from the identification stage, thereby, undesirably increasing the number of records that the human examiner's has to manually review to verify a true match. Accordingly, it is desirable to provide a reliable measurement of print image quality to reject bad quality images under controlled environments, such as fingerprint enrollment, to eliminate these images from the identification process.

Although such a strategy is feasible in controlled environments, it is not so feasible in uncontrolled environments such as crime scenes. For example, many latent prints lifted from a crime scene are not of the best quality because they are generally unknowingly left by people. Moreover, the quality of latent prints typically widely varies from latent print to latent print. However, a search record is desirably made from every latent print at a crime scene to compare against a file record database in an attempt to identify one or more suspects for a crime. Therefore, these latent prints cannot be rejected simply because they do not meet some quality threshold. Accordingly, a simple accept/reject strategy of print images is not enough to completely address the image quality issues. Instead, a numerical quality metric is more desirable to measure the quality of accepted and existing prints (e.g., fingerprints) in order to adaptively process them in later stages of image processing and identification.

Image quality based matching has been proven successful to improve accuracy. Thus, an accurate assessment of print image quality can be important in a print matching process. There are many known methodologies to compute print image quality (e.g., associated with fingerprints). Some of the earlier methodologies strive to characterize the traditional visual image-based features such as contrast, curvature etc, to measure the fingerprint quality. It is further widely accepted that in order to reliably predict fingerprint identification performance, the quality of the fingerprint minutiae should also be considered as a feature since nearly all of the fingerprint identification systems are based on minutiae matching. Known methodologies, therefore, typically summarize all of the above-referenced features and input these features into decision logic units and/or pattern classifiers to determine the overall fingerprint image quality.

However, there is a critical problem that none of these methods deals with. When two fingerprint images are matched against each other, the identification result is not only dependent on the visual quality metrics mentioned above, but also dependent on the registration, e.g., how much common region exist between two fingerprints. If the images are taken from different parts of the fingerprint or the overlapping area is minimal, no matter how good the visual quality is, a satisfying identification result cannot be achieved.

Thus, there exists a need for a comprehensive print image (e.g., fingerprint image) quality computation methodology that takes the overlapping region problem into consideration from the beginning, and computes fingerprint quality only in this region. The overlapping region estimation, together with the existing visual features, will substantially improve the accuracy of the fingerprint quality computation, and in consequence the accuracy of AFIS.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an Automatic Fingerprint Identification System implementing embodiments of the present invention.

FIG. 2 illustrates a flow diagram of a detection stage method in accordance with an embodiment of the present invention.

FIG. 3 illustrates a more detailed flow diagram of a detection stage method in accordance with an embodiment of the present invention.

FIG. 4 illustrates detected pseudo-ridges used to implement embodiments of the present invention.

FIG. 5 illustrates various techniques for estimating a centroid of a physical print.

FIG. 6 illustrates a flow diagram of a training stage method in accordance with an embodiment of the present invention.

FIG. 7 illustrates a matching and non-matching distribution curve generated to use in determining quality parameters in accordance with embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for determining print image quality. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for determining print image quality described herein. The non-processor circuits may include, but are not limited to, user input devices. As such, these functions may be interpreted as steps of a method to perform the determining of print image quality described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a print image (e.g., fingerprint image) quality computation method, apparatus and computer-readable storage element based on matching region estimation is described. Unlike previous methods, where fingerprint image quality is computed based on the whole fingerprint area in the fingerprint image, the image quality is computed in accordance with the teachings herein based on “overlapping” or “common” regions that are likely to be matched against each other during the matching stage relative to the estimation of a centroid of an actual physical fingerprint that is represented by the fingerprint image. Thus, embodiments disclosed herein are designed to accurately estimate these common matching regions and to estimate the centroid of the actual physical print.

Moreover, fingerprint image quality features are calculated only from these regions and, in one embodiment, are weighted by other factors such as core and delta availability. The final print image quality is computed based on an optimized map function/logic and on region-size. The function and region-size are determined by a parametric or non-parametric estimation of pre-collected matching design data sets. Since the method addresses the matching region registration problem commonly existing in the matching stage of all AFIS, it broadens the concept of image quality and provides a more accurate estimation of the fingerprint image quality. Moreover using embodiments herein, the final quality measure determined for the fingerprint image is optimally correlated to a matching and non-matching distribution curve and proportional to matching scores associated with a matcher processor (e.g., a minutiae matcher processor) used in the identification stage. Those skilled in the art will realize that the above recognized advantages and other advantages described herein are merely exemplary and are not meant to be a complete rendering of all of the advantages of the various embodiments of the present invention.

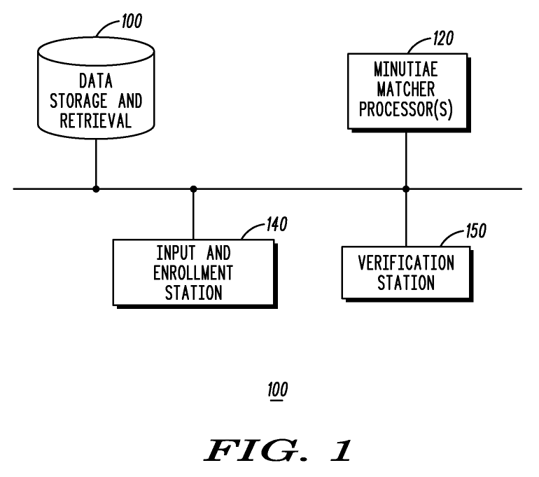

Referring now to the drawings, and in particular FIG. 1, a block diagram of an exemplary fingerprint matching system implementing embodiments of the present invention is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print or a known ten-print) to a database of file print records (e.g., that contain ten-print records of known persons) and identifies one or more candidate file print records that match the search print record. The ideal goal of the matching process is to identify, with a predetermined amount of certainty and without a manual visual comparison, the search print as having come from a person who has prints stored in the database. At a minimum, AFIS system designers and manufactures desire to significantly limit the time spent in a manual comparison of the search print to candidate file prints (also referred to herein as respondent file prints).

Before describing system 100 in detail, it will be useful to define terms that are used herein.

A print (also referred to herein as a “physical print”) is a pattern of ridges and valleys on the actual surface of a finger (fingerprint), toe (toe print) or palm (palm print), for example.

A centroid or centroid point of a physical print is the center of a region of the physical print that represents the center of likely common area used in a print matching process.

A print image is a visual representation of a print that is stored in electronic form. The print image includes a foreground area corresponding to the print and a background area that is included in a window frame surrounding the print image but is not representative of the print.

A gray scale image is a data matrix that uses values, such as pixel values at corresponding pixel locations in the matrix, to represent intensities of gray within some range.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where a ridge divides into two ridges.

A similarity measure is any measure (also referred to herein interchangeable with the term score) that identifies or indicates similarity of a file print to a search print based on one or more given parameters.

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise.

A direction field measure or value is the direction assigned to a point (e.g., a pixel location) or block on the direction field image and can be represented, for example, as a slit sum direction, an angle or a unit vector.

A singularity point is a core or a delta.

In a fingerprint pattern, a core is the approximate center of the fingerprint pattern on the most inner recurve where the direction field curvature reaches the maximum.

According to ANSI-INCITS-378-2004 standard, a delta is the point on a ridge at or nearest to the point of divergence of two type lines, and located at or directly in front of the point of divergence.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

Turning again to FIG. 1, an AFIS that may be used to implement the various embodiments of the present invention described herein is shown and indicated generally at 10. System 10 includes an input and enrollment station 140, a data storage and retrieval device 100, one or more matcher processors 120, e.g., minutiae matcher processors, and a verification station 150.

The input and enrollment station 140 may be configured for implementing the various embodiments of the present invention in any one or more of the processing devices described above. Moreover, input and enrollment station 140 is further used to capture fingerprint images to extract the relevant features (minutiae, cores, deltas, the direction image, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Matcher processors 120 use the extracted features of the fingerprint images to determine similarity or may be configured to make comparisons at the image level. One such matcher processor may be a conventional minutiae matcher for comparing the extracted minutiae of two fingerprint images. Finally, verification station 150 is used, for example by a manual examiner, to verify matching results.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

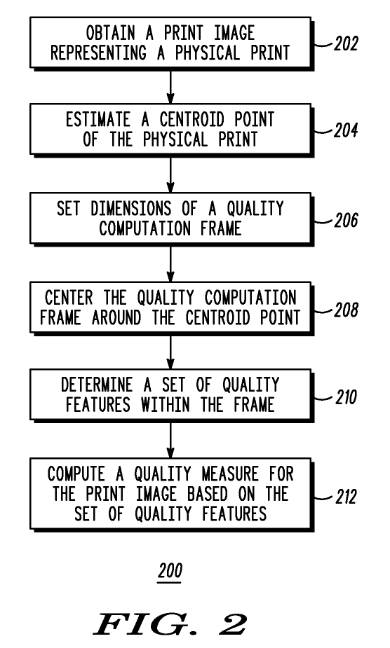

Turning now to FIG. 2, a high-level flow diagram illustrating an exemplary method for determining quality of a print image (e.g., fingerprint image, toe print image, palm print image) in accordance with an embodiment of the present invention is shown and generally indicated at 200. At step 202 a print image is obtained for processing, for example, a fingerprint image, a toe print image or a palm print image. At the remaining steps 204, 206, 208, 210 and 212, respectively: a centroid point of the physical print is estimated; dimensions of a quality computation frame are set based on a characteristic of the print image; the quality computation frame is centered around the centroid point; a set of quality features are determined within the frame, which may be weighted based on the centroid point of the physical print; and a quality measure for the print image is computed based on the set of quality features.

By computing the quality measure using quality features determined only within the frame -with the frame having dimensions based on a characteristic of the print image and centered around the estimated centroid point for the physical print- the quality computation takes into consideration overlapping regions between the print image and another print image that are likely to be matched against each other during the matching stage. Accordingly, print images associated with smaller overlapping regions are assigned a relatively lower quality measure, and print images associated with a larger overlapping region are assigned a relatively larger quality measure. The quality measure can, thereby, be used to eliminate enrolled images from the matching process that do not satisfy a quality metric. In addition where such elimination is not feasible (such as in the case of latent prints), a quality measure that takes into account overlapping regions (as well as traditional features used in print image quality determination) can result in improving accuracy during the print matching process.

In one embodiment related to fingerprint image processing, the dimensions (which, as used herein, can include shape, (x, y) coordinate dimensions and any other suitable spatial measure) of the quality computation frame and a quality function used to compute the quality measure using the quality features are determined during a process referred to herein as the “training stage”. During the training stage, a quality function and dimensions for a quality computation frame (associated with a plurality of captured images that have the same associated finger number and impression method used to capture the print image whose quality is being determined) are optimally correlated to a matching and non-matching distribution curve and proportional to matching scores generated based on the plurality of images. This optimized quality function and dimensions for the quality computation frame are used in what is referred to herein as the “detection stage” (which correlates to method 200) to compute the quality measure for the print image being processed. Ideally, such optimized quality functions and quality computation frame dimensions associated with numerous combinations of finger number and impression methods are determined and stored in a table in the data storage and retrieval unit 100, for example, for retrieval during the detection stage.

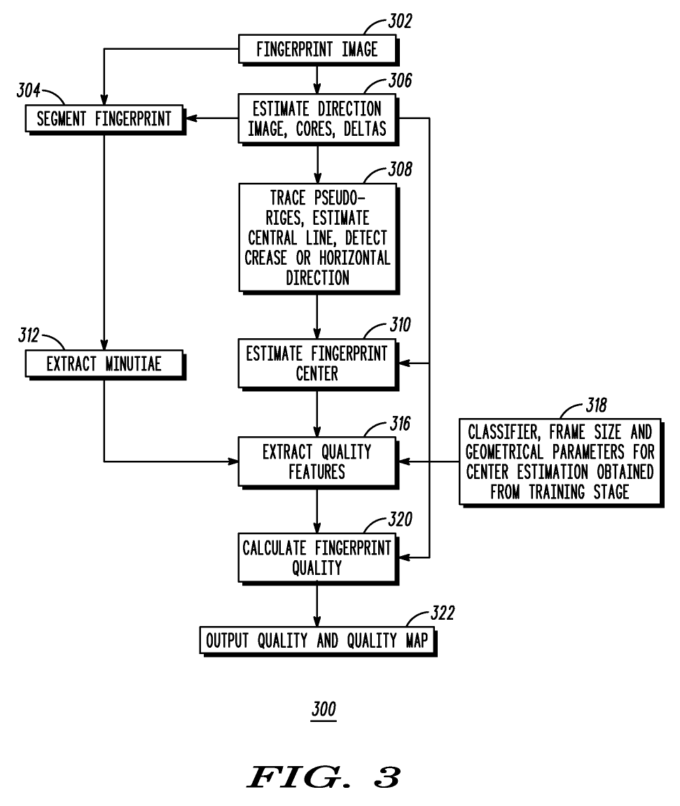

In FIG. 3, a flow diagram of a more detailed method 300 (corresponding to a detection stage embodiment) for implementing the steps of method 200 is shown. This method includes the beneficial implementation details that were briefly mentioned above. Moreover, method 300 is described in terms of a fingerprint identification process (such as one implemented in the AFIS shown in FIG. 1) for ease of illustration. However, it is appreciated that the method may be similarly implemented in biometric image enrollment for other types of prints such as, for instance, palm prints or toe prints without loss of generality. Thus, these other types of prints and images are contemplated within the meaning of the terms “print” and “fingerprint” as used in the various teachings described herein.

An overview of method 300 will first be described, followed by a detailed explanation of an exemplary implementation of method 300 in an AFIS. A fingerprint image (302) is received into the AFIS via any suitable interface. For example, the fingerprint image 302 can be captured from someone's finger using a sensor coupled to the AFIS or the fingerprint image could have been scanned into the AFIS from a ten-print card, for example, used by a law enforcement agency. The fingerprint image is stored electronically in the data storage and retrieval unit 100. Moreover, the impression type or method (e.g., roll, slap, etc.) and finger number (e.g. 1-10 moving from left to right from the pinky on the left hand to the pinky on the right hand) are stored with the fingerprint image. The remaining steps are implemented using a processing device.

For the fingerprint image 302 (with its specific impression type and finger number), a boundary between fingerprint areas (also known in the art as the “foreground”) and non-fingerprint areas (also known in the art as the “background”) is detected (at a step 304), thereby segmenting out the foreground from the background of the fingerprint image. A direction image is generated from the fingerprint image, and cores and deltas are detected from the direction image (at a step 306). A group of pseudo-ridges are traced (at a step 308) on the direction image. A central line is estimated (step 308) based on the pseudo-ridges and the segmented fingerprint area. A crease of the fingerprint, if it exists in the image, is then detected (step 308) based on the segmented fingerprint area and direction field. If it does not exist, a horizontal direction or line, e.g., a bottom horizontal pseudo-ridge, is found (step 308). Minutiae are extracted from pre-processing (at a step 312). A physical fingerprint center estimation is performed (at a step 310), which is derived based on the segmented fingerprint region, the detected crease or horizontal line, the traced pseudo-ridges and the detected core/delta, with the aid of prior statistical knowledge from a large fingerprint database in the training stage (from a stage 318). After the physical fingerprint center is estimated, quality of the fingerprint image is computed (at a step 320) based on quality features extracted (at a step 316) solely within a frame centered at the physical fingerprint center. The quality computation is made using a classifier (or function) obtained in the training stage (stage 318). Dimensions of the frame are also obtained from the training stage (stage 318). The image quality and an image quality map are output (at a step 322) for matching.

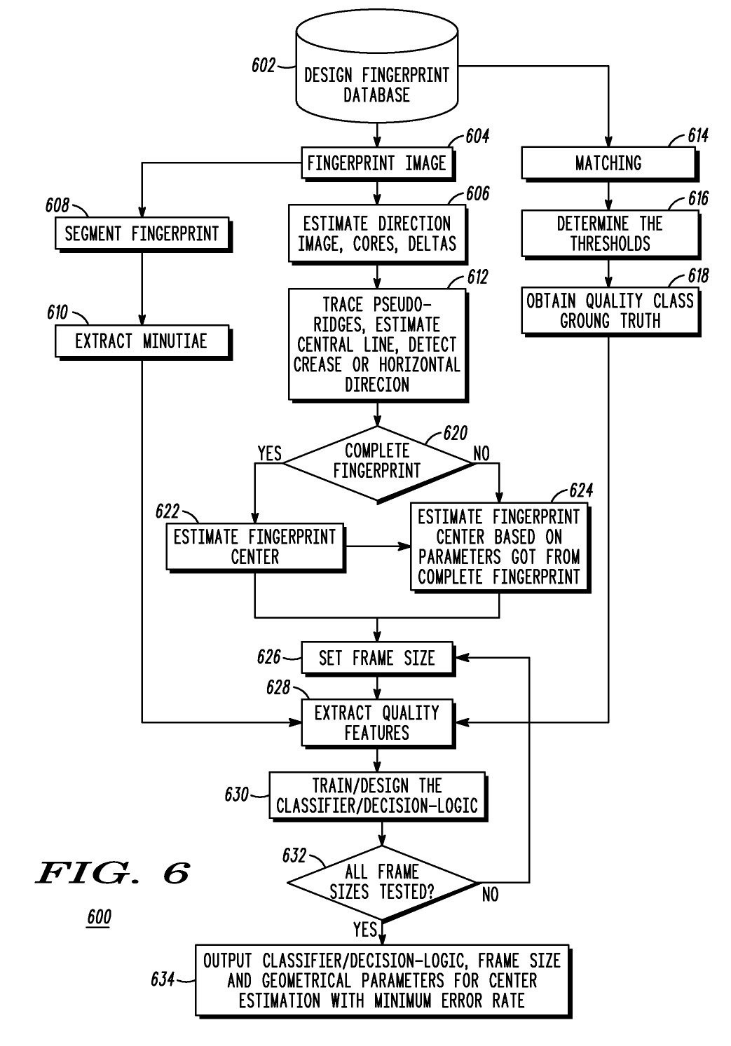

An explanation of exemplary implementations of method 300 is detailed as follows. It should be kept in mind that many different implementations can be envisioned based on methods 200, 300 and 600 (FIG. 6). However, only certain ones are described to aid in understanding the teachings disclosed herein. Thus, the described implementations are in no way intended to narrow the scope of embodiments of the invention.

At step 304 the fingerprint area is segmented out from the image. There are many methods that can be used to segment the fingerprint area. For example, gray level distribution between the fingerprint area and the background is different, which can be used to detect the fingerprint area. In one embodiment, the estimation of direction image and core/delta detection are performed in one step (step 306) through an iterative hierarchical method. Using this method, the direction image is smoothed with the detected core/delta as a reference. After the direction image is smoothed, the core/delta are detected again and the information is fed back to direction image smoothing. This procedure is iteratively executed until the direction image is sufficiently smooth based on a predetermined direction image consistency metric. Those of ordinary skill in the art will realize that the teachings herein are not limited to the optimized direction image construction and core/delta detection described above. Other traditional methods can be used such as those implementing fixed-window smoothing. Using the direction image to enhance the image with Gabor filter, for example, the minutiae are extracted (at step 312) from the fingerprint area after binarization and thinning.

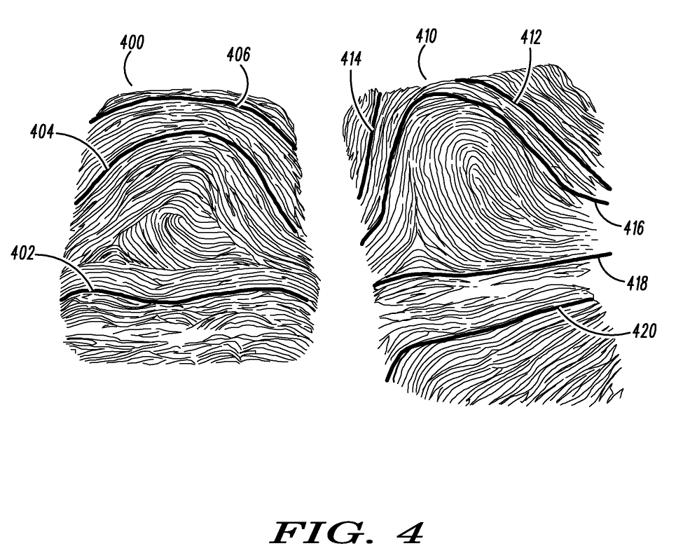

To trace the pseudo-ridges (in step 308), the direction image is subdivided into blocks and the direction (referred to herein as a direction measure) in each block is obtained through majority voting. Starting from every block on the border of the fingerprint area, which is found in step 304, a pseudo-ridge is traced until it hits the border again or it comes back to its original starting location. Repeating pseudo-ridges starting from different border blocks are found and eliminated. All the pseudo-ridges, including the coordinates of every block on the ridge, are recorded and retained for further use. FIG. 4 illustrates two fingerprint images 400, 410 and their traced pseudo-ridges, respectively, 402, 404 and 406 (in image 400) and 412, 414, 416, 418 and 420 (in image 410).

Fingerprint images having acceptable quality typically have associated therewith one or more detected substantially bell-shaped pseudo-ridges, such as pseudo-ridges 404 and 406 (from image 400) and 416 (from image 410). These bell-shaped ridges can be found by the analysis of maximum curvature and symmetry of the ridge, using the following exemplary procedure. If the ending points of a ridge are at the border of the fingerprint area, select this ridge as a candidate. The maximum curvature point is found and its normal direction is also found. If the maximum curvature is greater than some threshold, measure the distance from the maximum curvature point to the two ends of the ridge. If the difference between two distances is below a predetermined threshold that is determined in accordance with application requirements, project the two ending points of the ridge onto the normal direction of the maximum curvature point. If the distance between the two projected points is less than some threshold, the ridge is declared as a bell-shaped ridge.

The maximum curvature points of these bell-shaped pseudo-ridges are found and fitted to a straight line, which is the central line (step 308) of the fingerprint. Its direction represents the rotation angle of the fingerprint with respect to the vertical direction. When the quality of a fingerprint image is really bad or the fingerprint image is partial, there is an insufficient number of reliable bell-shaped ridges available for determining the central line. In this case, the central line can be estimated through a shape analysis of the fingerprint area. The long axis of the fingerprint area can be considered as the central line.

When we consider fingerprint matching, it is the part above a top crease in the fingerprint that is of interest. Thus crease detection (step 308) is desirable. The crease can be found through the following exemplary pseudo-ridge analysis. If at least a bell-shaped ridge exists, starting from the first found bell-shaped ridge, move downwards ridge by ridge. If a pseudo-ridge's maximum curvature is found below a predetermined threshold set according to application requirements, continue down three more ridges and stop. Fit a straight line to the last ridge found, which can be determined as the crease.

If at least a bell-shaped ridge exists, but no pseudo-ridge is found to have maximum curvature below the threshold, this means that the finger tip part of the fingerprint was captured. A no-crease situation can be declared. If no bell-shaped ridge exists, find the top-most ridge whose angle between the central line is within a predetermined threshold of 90° set according to application requirements. If there are ridges above this ridge, whose angle between the central line is less than a predetermined threshold set according to application requirements, continue down three more ridges and stop. Fit a straight line to the last ridge found, and it can be determined as a crease.

If the top-most ridge exists but it does not have above ridges satisfying the small angle condition as described above, the fingerprint image area is either under the crease or above the crease with only a bottom portion of the print captured. A no-crease situation can be declared. Finally, if the top-most ridge does not exist, this fingerprint image is a partial, such as a finger tip. A no-crease situation can be declared.

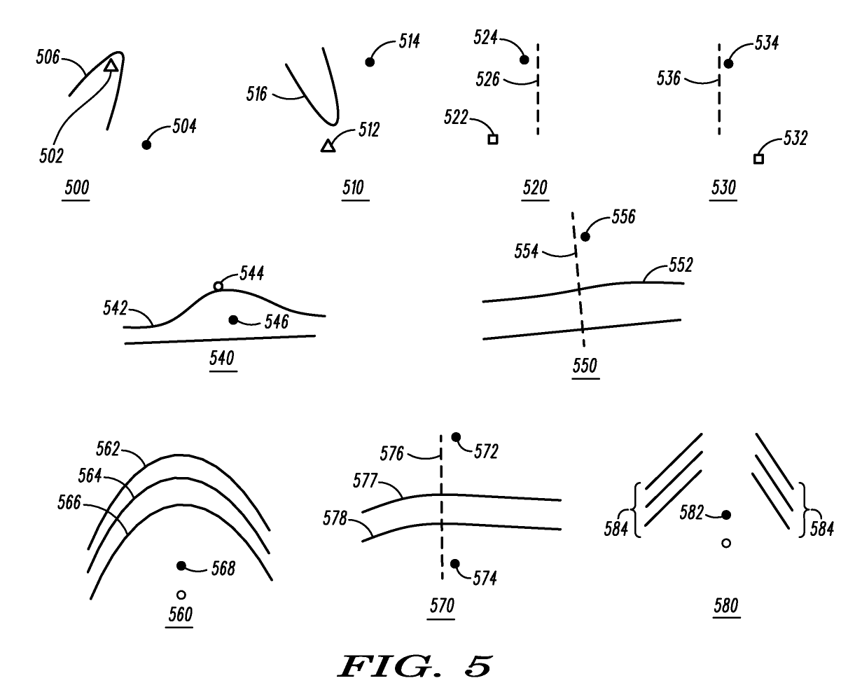

The actual physical fingerprint centroid can be determined (step 310), for example, using the following exemplary techniques 500 through 580 illustrated in FIG. 5. In accordance with a technique 500, a core (502) with direction (506) pointing downwards is detected. The centroid point (504) is found at a certain distance D₁ to the core. An angle between the line segment connecting the core and center line is θ₁, where D₁ and θ₁ are found during training stage.

In accordance with a technique 510, a core (512) with direction (516) pointing upwards is detected. The centroid point (514) is found at a certain distance D₂ to the core. The angle between the line segment connecting the core and center line is θ₂, where D₂ and θ₂ are found during training stage.

In accordance with a technique 520, a delta (522) is detected on the left side of a central line (526). The centroid point (524) is found at a certain distance D₃ to the delta. An angle between the line segment connecting the delta and center line is θ₃, where D₃ and θ₃ are found during training stage.

In accordance with a technique 530, a delta (532) is detected on the right side of a central line (536). The centroid point (534) is found at a certain distance D₄ to the delta. An angle between the line segment connecting the delta and center line is θ₄, where D₄ and θ₄ are found during training stage.

Where any of the combination of 500 through 530 is found, the centroid point location can be found through the mean coordinates, which is a technique that is well known in the arts.

In accordance with a technique 540, where no core and delta is found, if the fingerprint is a sure arch classification type, find a point (544) on the pseudo-ridges (542) with maximum curvature. The centroid point (546) is found at a certain distance D₅ to that point. An angle between the line segment connecting the point and center line is θ₅, where D₅ and θ₅ are found during training stage.

In accordance with a technique 550, where no core and delta is found, if the fingerprint is not a sure arch but a crease (552) is detected, find a crossing point between the central line (554) and the crease. The centroid point (556) is found at a certain distance D₆ to that point. An angle between the line segment connecting the point and center line is θ₆, where D₆ and θ₆ are found during training stage.

In the next three techniques, no core and delta is found, the fingerprint image is not a sure arch and no crease exists. This fingerprint image is a partial as discussed above. Thus, in accordance with a technique 560, a finger tip is captured. An average focal point of all the bell-shaped ridges (e.g., 562, 564, and 566) is found. The centroid point (568) is found at a certain distance D₇ and angle θ₇, which are obtained during the training stage.

In accordance with a technique 570, the centroid point can be either up (572) or down (574) the captured fingerprint image. Relative to a crossing point of the central line (576) and a top-most ridge (577) and bottom-most ridge (578), two sets of parameters, D₈ and θ₈, D₉ and θ₉ are used to estimate the location of the fingerprint center. These parameters are determined during the training stage.

In accordance with a technique 580, a partial finger tip is captured. After curve fitting, an average focal point of all the bell-shaped ridges (584) is found. The fingerprint centroid (582) can be found at a certain distance D₇ and angle θ₇, where these parameters are determined during the training stage. In all other cases, the fingerprint image is declared as invalid. The quality is set to be the lowest.

To extract the quality features at step 316, a block-based image quality map is generated for the foreground area of the image. In one embodiment, the block size is 16×16 and a sub-sampling rate is 8. For every block at least one parameter used to determine the quality features is determined and assigned to the block. These parameters may include, but are not limited to, contrast, ridge frequency and majority-voted direction (as represented by a suitable direction measure) are computed. Where a block has no direction and the ridge frequency cannot be estimated, such a block can be assigned a no-direction and no-ridge-frequency.

After calculation of the image quality map, a frame is set around the estimated centroid point. In one embodiment, the frame's dimensions (e.g., shape and size) are found in the training stage as detailed below by reference to FIG. 6. Only the quality features inside the frame are computed. In one embodiment, the following six exemplary quality features F1 through F6 can be determined during this step:

F1: the weighted percentage of the blocks with direction inside the frame.

F2: the weighted percentage of the blocks without direction inside the frame.

F3: the weighted number of minutiae inside the frame.

F4: the weighted percentage of the blocks with ridge frequency inside the frame.

F5: the weighted percentage of the blocks without ridge frequency inside the frame.

F6: the weighted percentage of the blocks with dynamic range less than a threshold T inside the frame, where T is determined experimentally.

Weighting is optional but assists is emphasizing some areas over others to further optimize the results. The weighting scheme can be, for example, any substantially bell shaped function centered on the estimated centroid point. In one embodiment, the weighting function is a two dimensional Gaussian function such as:

$$W ( x , y ) = {e}^{- \frac{{( x - {x}_{0} )}^{2}}{{c}_{x}} - \frac{{( y - {y}_{0} )}^{2}}{{c}_{y}}}$$

The six features are fed (step 320) into a classifier/function/decision-logic obtained in the training stage, and the fingerprint image is classified into one of six quality classes determined in the training stage. Both the image quality map and determined quality measure are output (step 322) for use in the fingerprint matching stage.

FIG. 6 is a block diagram illustrating the training stage to generate quality parameters for use is the detection stage for each of a number of impression type/finger number combinations. At a step 602 a design database is collected having a plurality of fingerprint images associated with numerous impression type/finger number combinations. The database is collected and corresponding matching performed (at a step 614) in the following manner. For M people, ten fingerprints images are collected N different times with different qualities. Every one impression among these N impressions is matched against all other N-1 impressions of the same finger number. The highest score is considered as the indexing score of this impression and this finger number for quality training. Different types of impressions, such as flats and rolls, are collected. The training is performed separately for different impression types and finger numbers.

For each of at least a subset of the collected fingerprint images (604), the follow pre-processing steps are performed: segmentation (at a step 608), direction image estimation (at a step 606), core/delta detection (step 606), pseudo-ridge tracing (at a step 612), and central line and crease/horizontal line detection (step 612). These preprocessing steps can be performed in the same manner as respective steps 304, 306 and 308 of FIG. 3, the detailed explanation of which will not be repeated here for the sake of brevity.

However, actual physical fingerprint centroid estimation (at steps 620, 622 and 624) is modified from how it is performed at step 310 in FIG. 3, since in FIG. 6, it is only performed based on complete fingerprint images. A complete fingerprint image contains at least one bell-shaped curve and a crease. Thereafter, parameters obtained through complete fingerprint images are used to estimate the fingerprint centroid associated with the partial fingerprint images. Moreover, after obtaining the ground truth (at a step 618) of quality classes from the fingerprint matching scores, different combinations of frame shape, size and classifier are tested (at steps 626, 628, 630 and 632). The one combination associated with a quality estimation error (that is less than a predetermined error threshold that is determined based on application design requirements) or that generates the lowest error (e.g., after a predetermined maximum number of iterations) is finally selected (at a step 634) and passed to the detection stage either on the fly or from a table of pre-computed quality parameters.

Turning to the details of physical fingerprint centroid estimation as determined in steps 620, 622 and 624. As stated above, the centroid on complete fingerprints images is estimated (at step 622 with the decision being made in step 620). A distance d between two crossing points is found: the first crossing point is between the central line and top border of the fingerprint. The second crossing point is between the central line and the crease. If d>512, the middle point of d is can be considered as the centroid point. Otherwise, the point 256 pixels above the central line and crease crossing point is considered as the centroid point.

After finding the centroid point of a complete fingerprint, geometrical characteristics between different parts of the fingerprint, e.g., D₁-D₉ and θ₁-θ₉ can be calculated, and the fingerprint centers for other partial prints in the database are found through the Dᵢs and θᵢs.

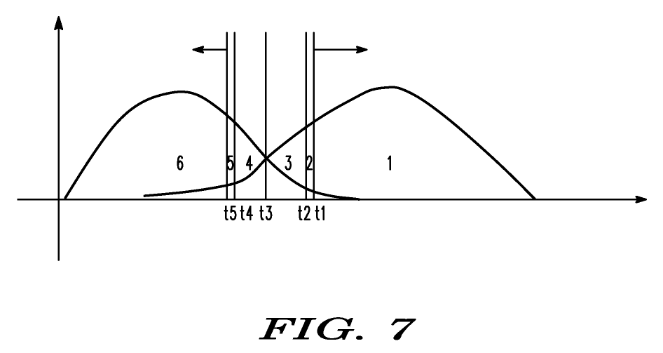

At step 618, quality class “ground truth” is determined which comprises the quality classifications or measures into which a print image can be categorized. The ground truth is determined as follows. For one impression type and one finger number, perform matching on the database for every pair of the fingerprints images (step 614). The matching and non-matching scores typically follow the matching and non-matching distribution curve as shown in FIG. 7. Five thresholds, t1-t5 are determined (at a step 616) to obtain a desired TAR/FAR number. The quality of the fingerprints is put into one of the six classes 1 through 6 determined by the thresholds, wherein area 6 represents a sure non-match area/section and area 1 represents a sure match area/section. The quality class selected based on the mated prints matched score falls into these corresponding area/sections. For example, if the value of mated print pair matched score is in the section 6, this means the quality of prints is bad and the quality caused them not to be able to match each other.

At step 628, quality features are determined in the same manner as in step 316, the detail of which will not be repeated here for the sake of brevity. The only difference is that during the training stage frame size is continually adjusted and the feature quality, correspondingly recomputed, to optimize the parameters output from this stage.

“Training” of a classifier is performed at step 630. Choose a specific classifier such as traditional Bayesian Classifier or a neural network and train it to obtain the parameters using the quality features extracted from all the fingerprint images of the same impression type and finger number. Do the testing on the training set to find out the error rate. The goal is to minimize the classification error rate between the designed classifier output results and the labeled ground truth class corresponding to the input quality features.

For each impression type and finger number, repeat the steps 628 and 630 for different frame shapes, sizes, and classifiers. Find a combination of shape, size and classifier with the lowest error rate, for example, as obtained in step 630. Together with the Dᵢs and θᵢs calculated in step 622, these are all the functions and parameters needed for the quality classification in the detection stage.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for determining quality of a print image representing a physical print of a person, the method comprising the steps of:
estimating a centroid point of the physical print;
setting dimensions of a quality computation frame based at least on a characteristic of the print image;
centering the quality computation frame around the centroid point;
determining, within the frame, a set of quality features; and
computing a quality measure for the print image based on the set of quality features.

2. The method of claim 1 further comprising the steps of:
detecting any singularity point associated with the print image;
determining a plurality of pseudo-ridges associated with the print image;
determining a classification of the print image;
detecting any crease or determining a horizontal line associated with the print image; and
detecting a central line associated with the print image, wherein the centroid point of the physical print is estimating based on at least one of any detected singularity point, the plurality of pseudo-ridges, the classification of the print image, any detected crease or determined horizontal line, and the central line.

3. The method of claim 2, further comprising the step of detecting a boundary between print areas and non-print areas in the print image, and wherein:
the central line is estimated based at least on one of the detected boundary and the plurality of pseudo-ridges; and
any crease is detected or horizontal line determined based on the plurality of pseudo-ridges.

4. The method of claim 2, wherein when the print image comprises a partial print, the centroid point is estimated based at least on one of the plurality of pseudo-ridges that is substantially bell-shaped.

5. The method of claim 1 further comprising the steps of:
generating an image quality map based on the print image and comprising a plurality of blocks each assigned at least one parameter; and
determining a set of minutiae point locations associated with the print image, wherein the quality features are determined based on the at least one parameter assigned to at least a portion of the blocks and the set of minutiae.

6. The method of claim 5, wherein the at least one parameter comprises at least one of contrast, ridge frequency and a direction measure.

7. The method of claim 6, wherein the set of quality features comprises at least one of:
a percentage of the blocks assigned a direction measure;
a percentage of the blocks not assigned a direction measure;
a number of minutiae within the frame;
a percentage of the blocks assigned ridge frequency;
a percentage of the blocks not assigned ridge frequency; and
a percentage of the blocks assigned a dynamic range that is less than a predetermined threshold.

8. The method of claim 1 further comprising the step of applying a weighting function to at least one quality feature in the set before the at least one quality feature is used to compute the quality measure.

9. The method of claim 8, wherein the weighting function comprises a substantially bell-shaped function centered on the centroid point.

10. The method of claim 9, wherein the weighting function comprises a Gaussian function.

11. The method of claim 1 further comprising the step of estimating a quality function used to compute the quality measure and determining the dimensions of the quality computation frame.

12. The method of claim 11, wherein the quality function is estimated and the dimensions of the quality computation frame are determined based at least on one of a finger number associated with the print image and an impression method used to capture the print image.

13. The method of claim 12 further comprising the steps of:
generating a database comprising at least a plurality of print images having the same associated finger number and impression method as the print image;
generating a classifier curve based on the plurality of print images;
determining the quality function and the dimensions of the quality computation frame based on the classifier curve, wherein the combined quality function and dimensions generated are associated with a quality estimation error that is less than a predetermined threshold.

14. Apparatus for determining quality of a print image comprising:
an interface receiving the print image; and
a processing device coupled to the print image and performing the steps of:
estimating a centroid point of the physical print;
setting dimensions of a quality computation frame based at least on a characteristic of the print image;
centering the quality computation frame around the centroid point;
determining, within the frame, a set of quality features; and
computing a quality measure for the print image based on the set of quality features.

15. The apparatus of claim 14, wherein the apparatus is included in an Automatic Fingerprint Identification System (AFIS).

16. The apparatus of claim 14, wherein the processing device comprises at least one of: a microprocessor executing code, an Application Specific Integrated Circuit (ASIC), a field programmable gate array (FPGA) and a state machine.

17. A computer-readable storage element having computer readable code stored thereon for programming a computer to perform a method for determining quality of a print image, the method comprising the steps of:
estimating a centroid point of the physical print;
setting dimensions of a quality computation frame based at least on a characteristic of the print image;
centering the quality computation frame around the centroid point;
determining, within the frame, a set of quality features; and
computing a quality measure for the print image based on the set of quality features.

18. The computer-readable storage medium of claim 17, wherein the computer readable storage medium comprises at least one of a hard disk, a CD-ROM, an optical storage device and a magnetic storage device.
